(19) United States
(12) Patent Application Publication
(10) Pub. No.: US 2006/0027180 A1
(43) Pub. Date: Feb. 9, 2006

(54) Devices for holding a box bird caller

(76) Inventors: Anthony P. Rininger, Copley, OH (US); Todd P. Rininger, Medina, OH (US)

Correspondence Address: RENNER, KENNER, GREIVE, BOBAK, TAYLOR & WEBER, FIRST NATIONAL TOWER FOURTH FLOOR, 106 S. MAIN STREET, AKRON, OH, 44308, US

(21) Appl. No.: 11/176,623

(22) Filed: Jul. 6, 2005

Related U.S. Application Data
(60) Provisional application No. 60/592,820, filed on Aug. 2, 2004.

(51) Int. Cl. A01K 29/00

(52) U.S. Cl. 119/165

(57) ABSTRACT

A device for holding a box bird caller includes a box, a paddle connected to the box at a hinge permitting movement of the paddle relative to the box to sound a bird call, and a handle extending from the paddle, the device including a caller sleeve having a paddle sleeve portion opposite a box portion; and a closure member joining a portion of said paddle sleeve portion to said box portion and forming an insertion end for the bird caller, wherein, when the bird caller is inserted through said insertion end, said paddle sleeve portion intimately contacts the paddle of the box caller, said box portion intimately contacts the bottom of the box, and said closure member urges said paddle sleeve portion and said box sleeve portion toward each other to keep the paddle in engagement with the box to prevent it from making noise.

### RELATED APPLICATIONS

This application claims the benefit of Provisional Patent Application No. 60/592,820 filed on Aug. 2, 2004.

### TECHNICAL FIELD

The present invention generally relates to bird hunting accessories, and, more particularly, to box bird callers.

### BACKGROUND OF THE INVENTION

As is well known in the art, hunting activities can require specialized accessories. Many items are provided for a hunter's basic needs, while speciality equipment and accessories that go far beyond a hunter's basic needs are also provided.

Of particular interest here are bird callers, more particularly, box bird callers. Currently, these items are typically carried by hunters, within pockets or packs, and are removed from such storage when needed. Unfortunately, they are needed quite often, and, during a given hunting expedition, a hunter must constantly store and retrieve his box bird caller.

The art can be improved by the provision of a device for carrying box bird callers wherein the device may be worn on the exterior of a hunter's clothing and always be available for use, without retrieving the box caller from a pocket or pack.

### SUMMARY OF THE INVENTION

This invention generally provides a device for holding a box bird caller having a box, a paddle connected to the box at a hinge permitting movement of the paddle relative to the box to sound a bird call, and a handle extending from the paddle, the device including a caller sleeve having a paddle sleeve portion opposite a box portion; and a closure member joining a portion of said paddle sleeve portion to said box portion and forming an insertion end for the bird caller, wherein, when the bird caller is inserted through said insertion end, said paddle sleeve portion intimately contacts the paddle of the box caller, said box portion intimately contacts the bottom of the box, and said closure member urges said paddle sleeve portion and said box sleeve portion toward each other to keep the paddle in engagement with the box to prevent it from making noise.

In another embodiment, this invention provides a device for holding a box bird caller having a box, a paddle connected to the box at a hinge permitting movement of the paddle relative to the box to sound a bird call, and a handle extending from the paddle, the device including a box sleeve that selectively receives the box of the box caller; a paddle sleeve portion secured to said box sleeve at a hinge; a pocket in said paddle sleeve that selectively receives the handle of the box caller; and a closure member that selectively secures said paddle sleeve portion to said box sleeve such that, when the box of the bird caller is received in said box sleeve and the handle of the box caller is received in said pocket, said paddle sleeve portion intimately contacts the surface of the paddle and said closure member brings the paddle into intimate contact with the box to prevent it from making noise.

### BRIEF DESCRIPTION OF THE DRAWINGS

FIG. 1 is a perspective view of an exemplary box caller of the prior art device for holding a box bird caller in accordance with this invention;

FIG. 2 is a perspective view of a first embodiment of a device for holding a box caller in accordance with this invention;

FIG. 3 shows the box caller of FIG. 2 as it holds a box caller such as that of FIG. 1;

FIG. 4 is a perspective view of a second embodiment of a device for holding a box caller in accordance with this invention, wherein the box caller may be sounded without removing it from the device and, in particularly preferred applications, without removing it from attachment to clothing or other items; and

FIG. 5 shows the box caller of FIG. 4 as it holds a box caller such as that of FIG. 1.

### PREFERRED EMBODIMENT FOR CARRYING OUT THE INVENTION

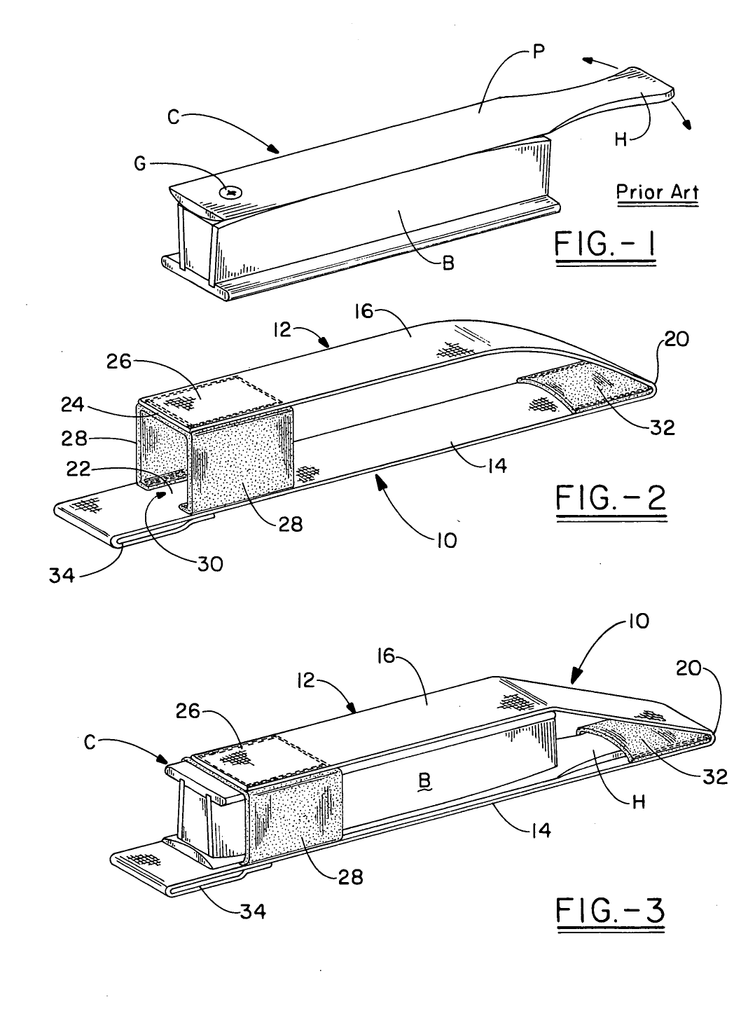

FIG. 1 shows a common box bird caller. Caller C includes paddle P that is connected to box B at hinge G. Box B is closed on all sides except for the side over which paddle P extends, and paddle P may be manipulated at handle H to make a bird sound by rubbing paddle P against the open side of box B. This is very well known, and box callers take this general form although they may be provided in different sizes and with different calling tones.

Referring now to FIGS. 2 and 3, a first embodiment for a device for holding a box bird caller in accordance with this invention is shown and designated by the numeral 10. Device 10 includes caller sleeve 12, which, in the preferred embodiment, is a continuous strip of material providing paddle sleeve portion 14 and box portion 16. This continuous strip of material folds at fold 20 so that paddle sleeve portion 14 and box portion 16 are opposed. Although it is preferred that paddle sleeve portion 14 and box portion 16 be formed of a continuous strip of material, it should be readily apparent that fold 20 could be replaced by stitching or another suitable connection of two separate strips of material. Preferably, paddle sleeve portion 14 and box portion 16 are formed from a rugged nylon material.

Opposite fold 20, paddle sleeve portion 14 and box portion 16 are kept in fairly close proximity at their respective insertion ends 22, 24 by closure member 26. Closure member 26 is formed by two opposed elastic members 28 secured between opposite sides of paddle sleeve portion 14 and forming an opening 30 for receipt of caller, such as caller C of FIG. 1. This is shown in FIG. 3, wherein a caller C has been inserted through opening 30. It can be seen that paddle sleeve portion 14 intimately contacts paddle P and handle H, while box portion 16 intimately contacts the bottom of box B opposed to handle H, and closure member 26 helps to squeeze and keep caller C closed, with paddle P engaging box B with sufficient force to prevent it from rocking and making noise. Handle pocket 32 is provided in paddle sleeve portion 14 to receive handle H and further help to secure caller C within device 10.

Belt loop 34 is provided to provide means for securing device 10 to the exterior of one's clothing so that the caller C retained therein is always ready for use out in the field. It will be appreciated that clip members could also be secured to various locations on device 10 for securing it to one's clothing. Belt loop 34 is merely preferred.

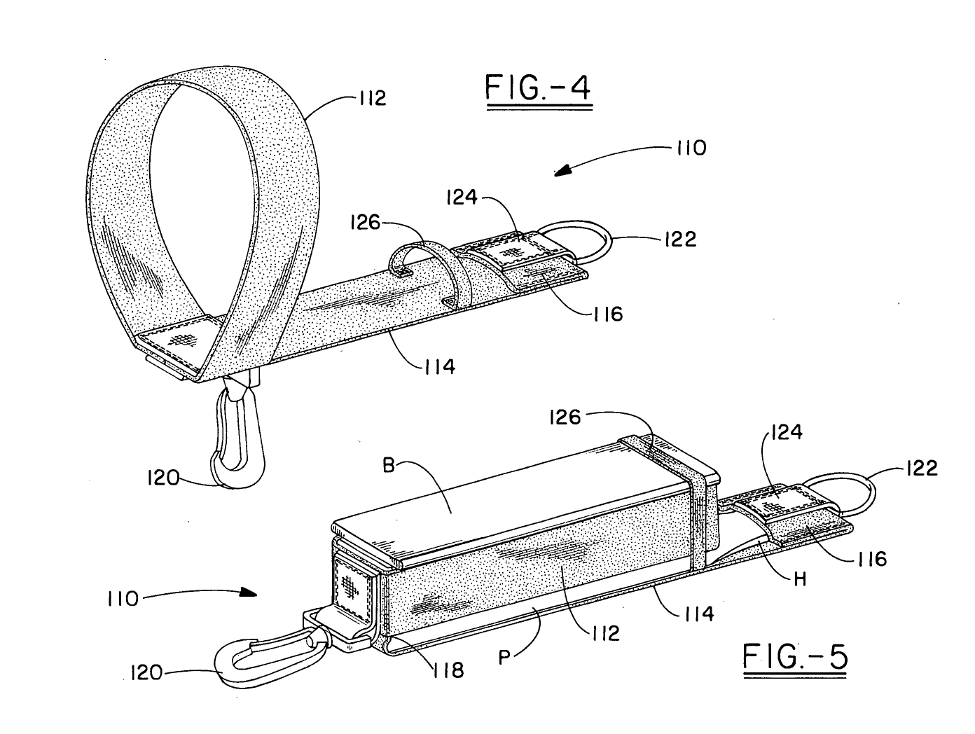

In developing the embodiment of device 10, it was determined that it would be very advantageous if the caller could be sounded while still being secured to the exterior of one's clothing, and, thus, a second embodiment, presented here in FIGS. 4 and 5 was developed. In those figures, a device for holding a box caller in accordance with a second embodiment of this invention is shown and designated by the numeral 110. Although certain aspects of this embodiment do relate to aspects of the embodiment of device 10, the numerals employed for this second embodiment are not to be related to the numerals employed for the first embodiment. Device 1 10 includes box sleeve 112, which is preferably an elastic loop capable of fitting around boxes B of various sizes. This fit is shown in FIG. 5. Paddle sleeve portion 1 14, providing handle pocket 116, is secured to box sleeve 1 12 at hinge 1 18. Thus, a caller C can be fit into device 110 by securing box sleeve 112 around, box B and inserting handle H of paddle P into handle pocket 1 16. Clip 120 is provided proximate hinge 1 18, and another clip 122 is provided extending from strap 124, at the opposite end of hinge 118. These provide alternative means for securing device 110 to one's clothing. Closure member 120 is provided extending between opposed sides of paddle sleeve portion 114 in order to wrap around box B to pull paddle P against box B with enough force to prevent it from sounding. It should be appreciated that device 1 10 can be worn in such a manner that permits the sounding of a call simply by releasing closure member 126 from around box B to permit the motion of paddle P about hinge G. An elastic closure member is preferred, but all types of closure means may be employed, including hook and loop closures, catch and latch closures, snap closures and the like. Indeed, although it is preferred that the closure member be attached as part of the device 10 as a whole, it could be provided as a separate element, for example, as a rubber band stretched around the box B and paddle P. What is important is that the closure member secure the paddle received in the paddle sleeve over the box received in the box sleeve, preferably to prevent rubbing and thus sounding.

The foregoing devices advance the art by providing a device for holding box callers wherein the device can be worn on the exterior of the body and always be ready for use. In the second embodiment, the box caller can be sounded without having to remove the box caller from the holding device. With the devices of this invention hung from the loop of a belt, a hunter can simply reach down, grab the caller, and either pull it out of the holding device for sounding, in the practice of the first embodiment, or sound it without removing it from the holding device, as in the second embodiment.

In light of the foregoing, it should be appreciated that the present invention provides devices for holding box callers that substantially improve the art. While specific materials have been disclosed, it will be appreciated that the present invention is not limited thereto or thereby, and other suitable materials will be readily apparent to those of ordinary skill in the art. Furthermore, while a caller design showing only one handle portion has been employed to disclose the present invention, it should be appreciated that the disclosure herein could be readily adapted to “boat” style box callers, which employ a handle such as that shown in prior art FIG. 1 at phantom handle H′. Thus, the present invention is not to be limited to or by any specific embodiment or description wherein. The claims will serve to define the invention.

What is claimed is:

1. A device for holding a box bird caller having a box, a paddle connected to the box at a hinge permitting movement of the paddle relative to the box to sound a bird call, and a handle extending from the paddle, the device comprising:
a caller sleeve having a paddle sleeve portion opposite a box portion; and
a closure member joining a portion of said paddle sleeve portion to said box portion and forming an insertion end for the bird caller, wherein, when the bird caller is inserted through said insertion end, said paddle sleeve portion intimately contacts the paddle of the box caller, said box portion intimately contacts the bottom of the box, and said closure member urges said paddle sleeve portion and said box sleeve portion toward each other to keep the paddle in engagement with the box to prevent it from making noise.

2. The device of claim 1 further comprising a pocket in said paddle sleeve portion for receiving the handle of the box caller.

3. A device for holding a box bird caller having a box, a paddle connected to the box at a hinge permitting movement of the paddle relative to the box to sound a bird call, and a handle extending from the paddle, the device comprising:
a box sleeve that selectively receives the box of the box caller;
a paddle sleeve portion secured to said box sleeve at a hinge;
a pocket in said paddle sleeve that selectively receives the handle of the box caller; and
a closure member, wherein, when the box of the bird caller is received in said box sleeve and the handle of the box caller is received in said pocket, said closure member selectively secures said paddle sleeve portion to said box sleeve such that said paddle sleeve portion intimately contacts the surface of the paddle and said closure member brings the paddle into intimate contact with the box to prevent it from making noise.

4. The device of claim 3, further comprising means for securing the device to the exterior of clothing.

5. The device of claim 4, wherein said means is selected from a clip, a belt loop, and a ring.
